(19) United States
(12) Patent Application Publication
(10) Pub. No.: US 2022/0015164 A1
(43) Pub. Date: Jan. 13, 2022

(54) ELECTRONIC DEVICE AND COMMUNICATION METHOD USING THE SAME

(71) Applicant: GEAR RADIO ELECTRONICS CORP., Hsinchu City (TW)

(72) Inventors: Tsung-Ling LI, Hsinchu City (TW); Chi-Hsueh WANG, Hsinchu City (TW)

(21) Appl. No.: 17/027,506

(22) Filed: Sep. 21, 2020

Related U.S. Application Data
(60) Provisional application No. 63/050,172, filed on Jul. 10, 2020.

(51) Int. Cl. H04W 76/14; H04R 1/10; H04W 76/30

(52) U.S. Cl. CPC H04W 76/14; H01R 33/18; H04W 76/30; H04R 1/10

(57) ABSTRACT

An electronic device includes a first electronic element and a second electronic element. The first electronic element stores a pairing information. The second electronic element is detachably disposed on the first electronic element. When the second electronic element is electrically connected with the first electronic element, the first electronic element is wirelessly communicated with a third electronic element. When the second electronic element is detached from the first electronic element, the second electronic element is wirelessly communicated with the third electronic element through the pairing information.

This application claims the benefit of U.S. provisional application Ser. No. 63/050,172, filed Jul. 10, 2020, the subject matter of which is incorporated herein by reference.

### FIELD OF THE INVENTION

The invention relates to a device and a method using the same, and more particularly to an electronic device and a communication method using the same.

### BACKGROUND OF THE INVENTION

In the wireless communication industry, each of a number of electronic elements wirelessly communicates with a host. However, in current communicating method, each electronic element is required to independently pair with the host through the pairing information stored itself. Therefore, it is important to increase pairing method among the host and the electronic elements.

### SUMMARY OF THE INVENTION

In one embodiment of the invention, an electronic device includes a first electronic element and a second electronic element. The first electronic element stores a pairing information. The second electronic element is detachably disposed on the first electronic element. When the second electronic element is electrically connected with the first electronic element, the first electronic element is wirelessly communicated with a third electronic element. When the second electronic element is detached from the first electronic element, the second electronic element is wirelessly communicated with the third electronic element through the pairing information.

In another embodiment of the invention, a communication method comprises the following steps. A first electronic element wirelessly communicating with a third electronic element when a second electronic element is electrically connected with the first electronic element, wherein the first electronic element stores a pairing information, and the second electronic element is detachably disposed on the first electronic element; and the second electronic element wirelessly communicating with the third electronic element through the pairing information when the second electronic element is detached from the first electronic element.

Numerous objects, features and advantages of the invention will be readily apparent upon a reading of the following detailed description of embodiments of the invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the invention will become more readily apparent to those ordinarily skilled in the art after reviewing the following detailed description and accompanying drawings, in which:

FIG. 1A illustrates a diagram view of a first electronic element being wirelessly communicated with a third electronic element according to an embodiment of the present invention;

FIG. 1B illustrates a diagram view of a second electronic element of FIG. 1A being wirelessly communicated with the third electronic element in a first operation mode;

FIG. 1C illustrates a diagram view of the second electronic element of FIG. 1A being wirelessly communicated with the third electronic element in a second operation mode;

FIG. 2 illustrates a flowchart of a communication method of the electronic device of FIG. 1A;

FIG. 3A illustrates a diagram view of the second electronic element being wirelessly communicated with the third electronic element when the second electronic element disconnects with the third electronic element according another embodiment of the present invention;

FIG. 3B illustrates a diagram view of the second wireless connection is disconnected when the second electronic element of FIG. 3A connects with the third electronic element;

FIG. 4 illustrates a flowchart of a communication method of the electronic device of FIG. 3A;

FIG. 5A illustrates a diagram view of the first electronic element being wirelessly communicated with the third electronic element through a fourth electronic element according to another embodiment of the present invention;

FIG. 5B illustrates a diagram view of the second electronic element of FIG. 5A being wirelessly communicated with the third electronic element in the first operation mode;

FIG. 5C illustrates a diagram view of the second electronic element of FIG. 5A being wirelessly communicated with the third electronic element in the second operation mode;

FIG. 6A illustrates a diagram view of the second electronic element being wirelessly communicated with the third electronic element when the second electronic element disconnects with the third electronic element according another embodiment of the present invention;

FIG. 6B illustrates a diagram view of the second wireless connection is disconnected when the second electronic element of FIG. 6A connects with the third electronic element;

FIG. 7A illustrates a diagram view of structure of the first electronic element of FIG. 1A; and

FIG. 7B illustrates a diagram view of the second electronic element being disposed thin the concave portion of FIG. 7A.

### DETAILED DESCRIPTION OF PREFERRED EMBODIMENTS

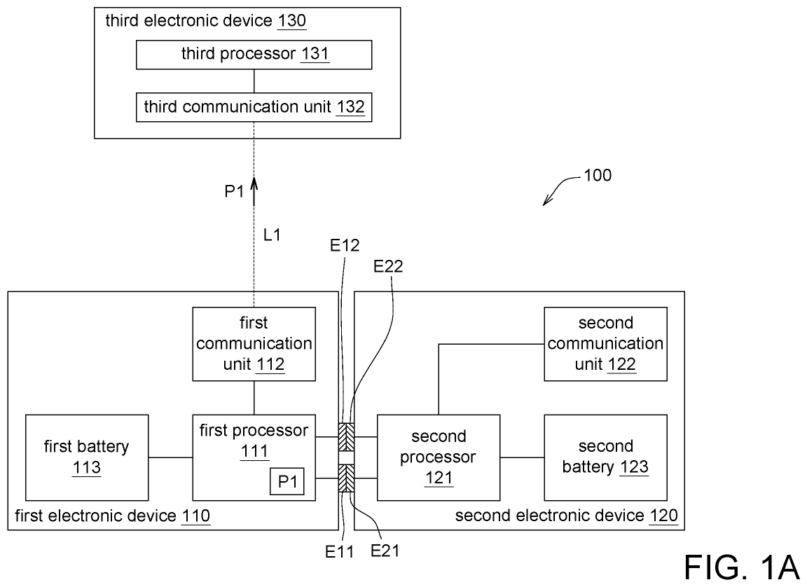

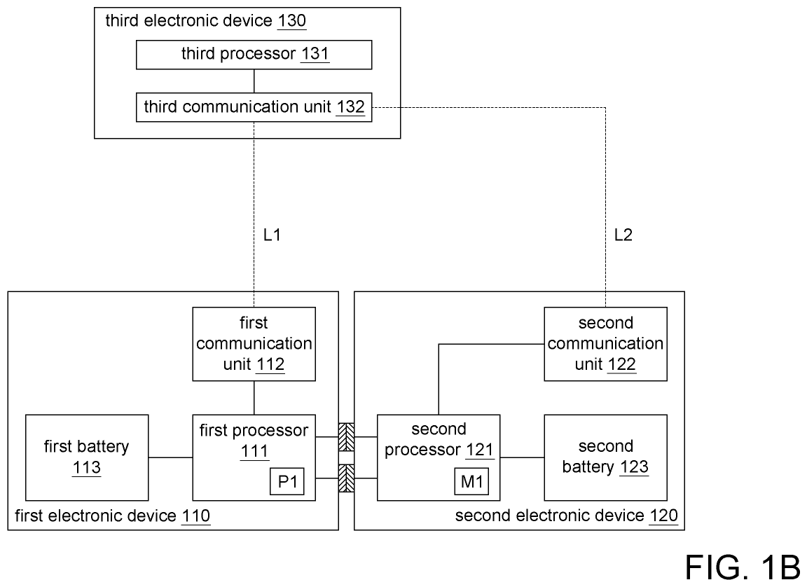

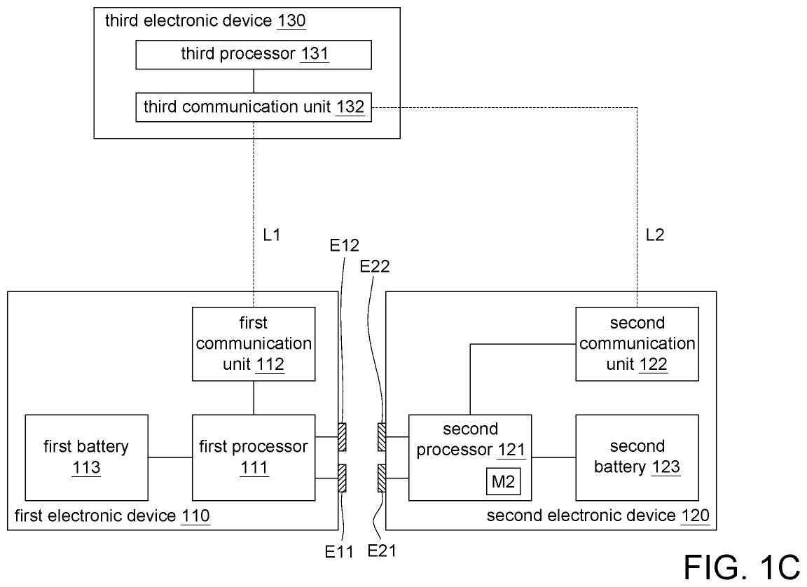

Referring to FIGS. 1A to 1C, FIG. 1A illustrates a diagram view of a first electronic element 110 being wirelessly communicated with a third electronic element 130 according to an embodiment of the present invention, FIG. 1B illustrates a diagram view of a second electronic element 120 of FIG. 1A being wirelessly communicated with the third electronic element 130 in a first operation mode M1, and FIG. 1C illustrates a diagram view of the second electronic.

Element 120 of FIG. 1A being wirelessly communicated with the third electronic element 130 in a second operation mode M2.

As illustrated in FIG. 1A, an electronic device 100 includes a first electronic element 110 and at least one second electronic element 120. The first electronic element 110 stores a pairing information P1. The second electronic element 120 is detachably disposed on the first electronic element 110. When the second electronic element 120 is electrically connected with the first electronic element 110, the first electronic element 110 is wirelessly communicated with a third electronic element 130 (as illustrated in FIG. 1A). When the second electronic element 120 is detached from the first electronic element 110, the second electronic element 120 is wirelessly communicated with the third electronic element 130 through the pairing information P1 (as illustrated in FIG. 10). As a result, the second electronic element 120 could be wirelessly communicated with the third electronic element 130 through the pairing information P1 after the second electronic element 120 is detached from the first electronic element 110.

In the present embodiment, the electronic device 100 excludes the third electronic element 130. However, in another embodiment, the electronic device 100 further includes the third electronic element 130.

In an embodiment, the first electronic element 110 is, for example, wireless input device, such as a wireless mouse, a keyboard, etc., the second electronic element 120 includes, for example, earbud, headset, etc., and the third electronic element 130 is, for example, a host, such as desktop computer, cellphone, notebook, etc.

In an embodiment, the first electronic element 110 wirelessly communicates with the third electronic element 130 through a communication protocol, the second electronic element 120 is communicated with the third electronic element 130 through the same communication protocol. The communication protocol is, for example, Bluetooth protocol, Proprietary protocol, etc.

In another embodiment, the first electronic element 110 wirelessly communicates with the third electronic element 130 through a first communication protocol, the second electronic element 120 wirelessly communicates with the third electronic element 130 through a second communication protocol different from the first communication protocol. The first communication protocol is, for example, Proprietary protocol, and the second communication protocol is, for example, Bluetooth protocol. Alternatively, the first communication protocol is, for example, Bluetooth protocol, and the second communication protocol is, for example, Proprietary protocol.

As illustrated in FIG. 1A, the first electronic element 110 includes a first processor 111, a first communication unit 112, a first battery 113, a first electrode E11 and a second electrode E12.

In an embodiment, the first processor 111 and/or the first communication unit 112 could be formed by semiconductor processes. In an embodiment, at least one of the first processor 111 and the first communication unit 112 could be circuit structure, such as semiconductor chip, semiconductor package, etc. In an embodiment, the first processor 111 and the first communication unit 112 could be integrated as one piece.

The pairing information P1 could be stored in the first processor 111 or a memory (not illustrated) of the first electronic element 110. The first processor 111 is electrically connected with the first communication unit 112, the first battery 113, the first electrode E11 and the second electrode E12. The first processor 111 is configured to detect whether the second electronic element 120 is detached from the first electronic element 110 according signal of the first electrode E11 and the second electrode E12. The first communication unit 112 is configured to communicate with the third electronic element 130.

The first communication unit 112 and the third electronic element 130 could a first wireless connection L1 between the first electronic element 110 and the third electronic element 130.

The first battery 113 could store electricity, and the first processor 111 could charge the second electronic element 120 using the electricity stored in the first battery 113 when the second electronic element 120 is electrically connected with the first electronic element 110.

The second electronic element 120 includes a second processor 121, a second communication unit 122, a second battery 123, a third electrode E21 and a fourth electrode E22.

In an embodiment, the second processor 121 and/or the second communication unit 122 could be formed by semiconductor processes. In an embodiment, at least one of the second processor 121 and the second communication unit 122 could be circuit structure, such as semiconductor chip, semiconductor package, etc. In an embodiment, the second processor 121 and the second communication unit 122 could be integrated as one piece.

The second processor 121 is electrically connected with the second communication unit 122, the second battery 123, the third electrode E21 and the fourth electrode E22. The second battery 123 could store the electricity from the first electronic element 110.

The second processor 121 is configured to: (1). when the second electronic element 120 is electrically connected with the first electronic element 110, the second processor 121 of the second electronic element 120 wirelessly communicates with the third electronic element 130 in the first operation mode M1 (as illustrated in FIG. 1B) through a second wireless connection L2 established between the second communication unit 122 and the third electronic element 130; (2). when the second electronic element 120 is detached from the first electronic element 110, the second processor 121 of the second electronic element 120 wirelessly communicates with the third electronic element 130 in the second operation mode M2 (as illustrated in FIG. 10) through the second wireless connection L2. In an embodiment, the first operation mode M1 is, for example, a sleep mode or a standby mode, and the second operation mode M2 is, for example, an active mode or an operating mode. In the active mode or the operating mode, the second electronic element 120 could be normally used, for example, playing music, adjust volume, skipping to next term (for example, song), skipping to the previous term (for example, song), power on, power off, etc.

As illustrated in FIG. 1A, when the first electrode E11 and the second electrode E12 of the first electronic element 110 are connected with (in contact with) the third electrode E21 and the fourth electrode E22 of the second electronic element 120 respectively, the second electronic element 120 is electrically connected with the first electronic element 110, and the first processor 111 could detect signal (for example, voltage signal) of the first electrode E11 and the second electrode E12. As illustrated in FIG. 10, when the first electrode E11 and the second electrode E12 of the first electronic element 110 are disconnected with (not in contact with) the third electrode E21 and the fourth electrode E22 of the second electronic element 120, the first processor 111 detects change of signal (for example, voltage signal) of the first electrode E11 and the second electrode E12 and accordingly determines that the second electronic element 120 is detached from the first electronic element 110. In other words, the first processor 111 could automatically detects whether the second electronic element 120 is detached from the first electronic element 110 according signal of the first electrode E11 and the second electrode E12.

The third electronic element 130 includes a third processor 131 and a third communication unit 132.

In an embodiment, at least one of the third processor 131 and the third communication unit 132 could be circuit structure, such as semiconductor chip, semiconductor package, etc. In an embodiment, the third processor 131 and the third communication unit 132 could be integrated as one piece.

The third processor 131 is electrically connected with the third communication unit 132. In an embodiment, the third processor 131 and/or the third communication unit 132 could be formed by semiconductor processes.

The third communication unit 132 of the third electronic element 130 and the first communication unit 112 of the first electronic element 110 could the first wireless connection L1 between the third electronic element 130 and the first electronic element 110.

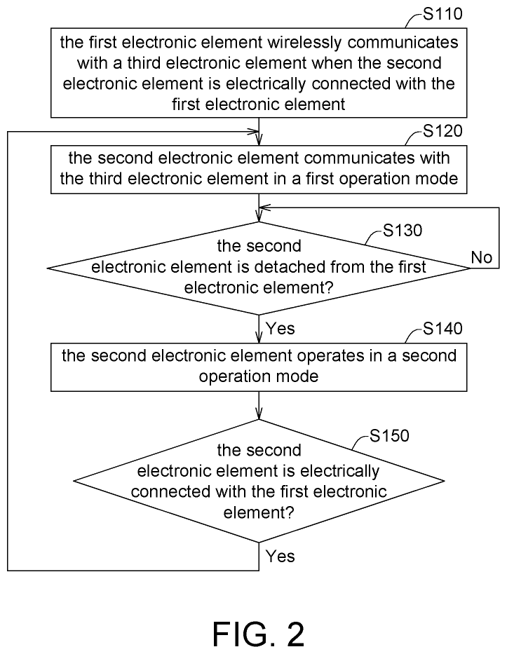

Referring to FIG. 2, FIG. 2 illustrates a flowchart of a communication method of the electronic device 100 of FIG. 1A.

In step S110, as illustrated in FIG. 1A, the first electronic element 110 wirelessly communicates with the third electronic element 130 when the second electronic element 120 is electrically connected with the first electronic element 110.

For example, as illustrated in FIG. 1A, the first communication unit 112 of the first electronic element 110 and the third communication unit 132 of the third electronic element 130 could establish the first wireless connection L1 by using a communication protocol, for example, Bluetooth protocol, Proprietary protocol, etc.

Then, as illustrated in FIG. 1A, the first electronic element 110 could transmit the pairing information P1 to the third electronic element 130 through the first wireless connection L1.

In step S120, as illustrated in FIG. 1B, the second electronic element 120 wirelessly communicates with the third electronic element 130, and the second processor 121 of the second electronic element 120 operates in the first operation mode M1.

Furthermore, as illustrated in FIG. 1B, the second communication unit 122 of the second electronic element 120 and the third communication unit 132 of the third electronic element 130 could establish the second wireless connection L2 by using the pairing information P1 in the third electronic element 130 and using the same communication protocol, for example, Bluetooth protocol, Proprietary protocol, etc.

Due to the second electronic element 120 being electrically connected with the first electronic element 110, it represents that the second electronic element 120 is not in available state or is not in operation state, the second processor 121 of the second electronic element 120 operates in the first operation mode M1.

In step S130, the first processor 111 of the first electronic element 110 determines whether the second electronic element 120 is detached from the first electronic element 110. If so, the process proceeds step S140; if not, the process returns to step S130.

In step S140, as illustrated in FIG. 1C, the second processor 121 of the second electronic element 120 operates in in the second operation mode M2.

Furthermore, due to the second electronic element 120 being detached from the first electronic element 110, it represents that user intends to use the second electronic element 120, the second processor 121 of the second electronic element 120 changes to operate in different mode, for example, the second mode M2.

As illustrated in FIGS. 1B to 10, the second electronic element 120 maintains communicating with the third electronic element 130 no matter whether the second electronic element 120 is connected with the third electronic element 130.

In step S150, the first processor 111 of the first electronic element 110 determines whether the second electronic element 120 is electrically connected with the first electronic element 110 again. If so, the process returns to step S120, the second processor 121 of the second electronic element 120 changes the operation mode to be the first operation mode M1, if not, the second electronic element 120 maintains operating in the second operation mode M2.

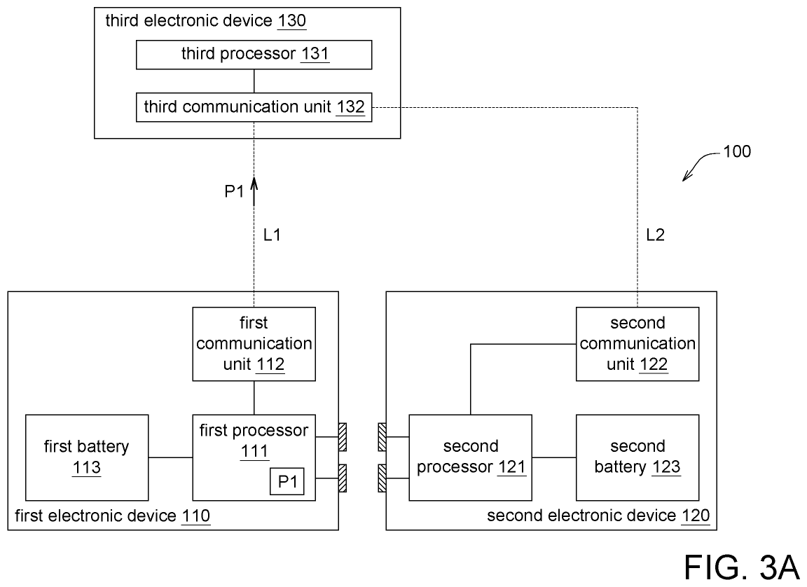

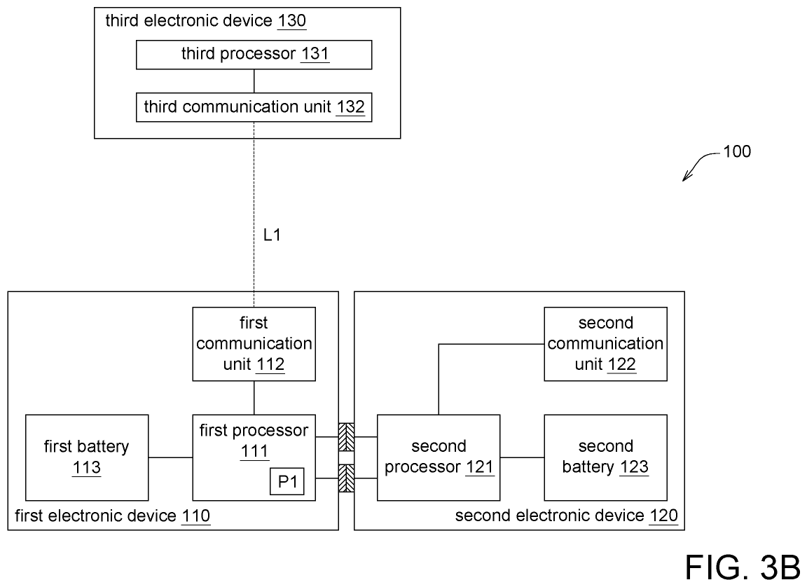

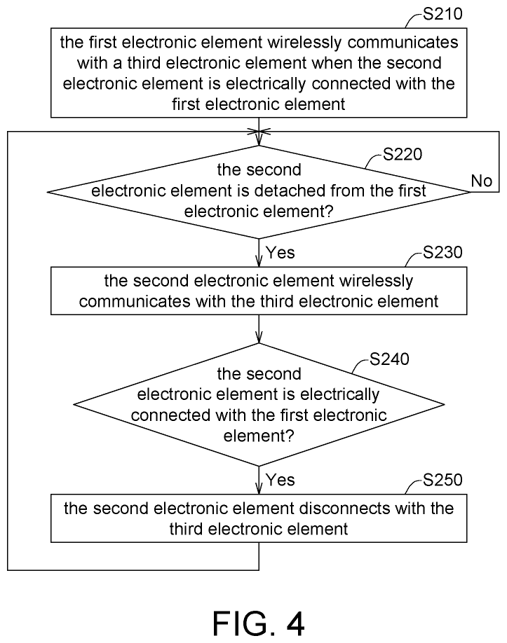

Referring to FIGS. 3A to 3B and 4, FIG. 3A illustrates a diagram view of the second electronic element 120 being wirelessly communicated with the third electronic element 130 when the second electronic element 120 disconnects with the third electronic element 130 according another embodiment of the present invention, FIG. 3B illustrates a diagram view of the second wireless connection L2 is disconnected when the second electronic element 120 of FIG. 3A connects with the third electronic element 130, and FIG. 4 illustrates a flowchart of a communication method of the electronic device 100 of FIG. 3A.

In step S210, as illustrated in FIG. 1A, the first electronic element 110 wirelessly communicates with the third electronic element 130 when the second electronic element 120 is electrically connected with the first electronic element 110.

For example, as illustrated in FIG. 1A, the first communication unit 112 of the first electronic element 110 and the third communication unit 132 of the third electronic element 130 could establish the first wireless connection L1 by using a communication protocol, for example, Bluetooth protocol, Proprietary protocol, etc.

Then, as illustrated in FIG. 1A, the first electronic element 110 could transmit the pairing information P1 to the third electronic element 130 through the first wireless connection L1.

In step S220, the first processor 111 of the first electronic element 110 determines whether the second electronic element 120 is detached from the first electronic element 110. If so, the process proceeds step S230; if not, the process returns to step S220.

In step S230, as illustrated in FIG. 3A, the second electronic element 120 wirelessly communicates with the third electronic element 130 through the pairing information P1 in the third electronic element 130 when the when the second electronic element 120 disconnects with the third electronic element 130.

Furthermore, in the present embodiment, the second communication unit 122 of the second electronic element 120 and the third communication unit 132 of the third electronic element 130 establish the second wireless connection L2 when the when the second electronic element 120 disconnects with the third electronic element 130.

In step S240, the first processor 111 of the first electronic element 110 determines whether the second electronic element 120 is electrically connected with the first electronic element 110 again. If so, the process proceeds step S250; if not, the second electronic element 120 maintains communicating with the third electronic element 130.

In step S250, as illustrated in FIG. 3B, the second electronic element 120 disconnects with the third electronic element 130 when the second electronic element 120 is electrically connected with the first electronic element 110. Then, the process returns to step S220.

Furthermore, in the resent embodiment, the second wireless connection L2 is disconnected when the second electronic element 120 disconnects with the third electronic element 130.

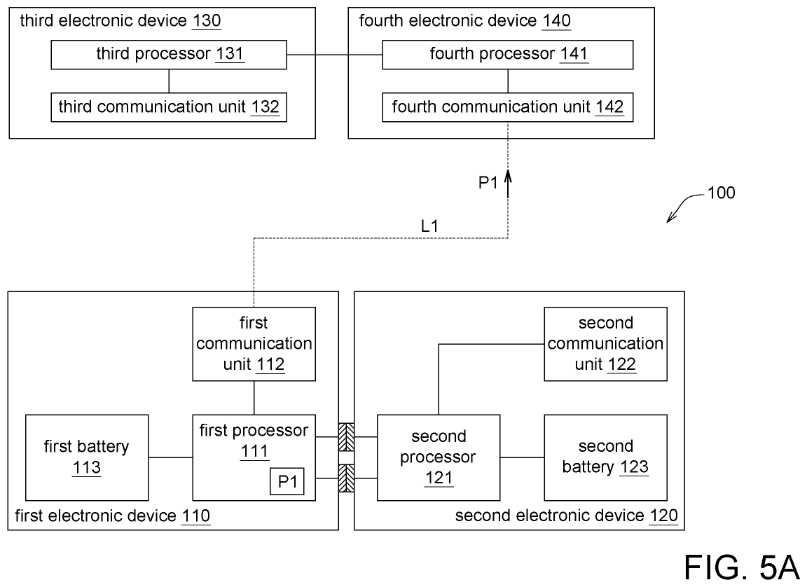

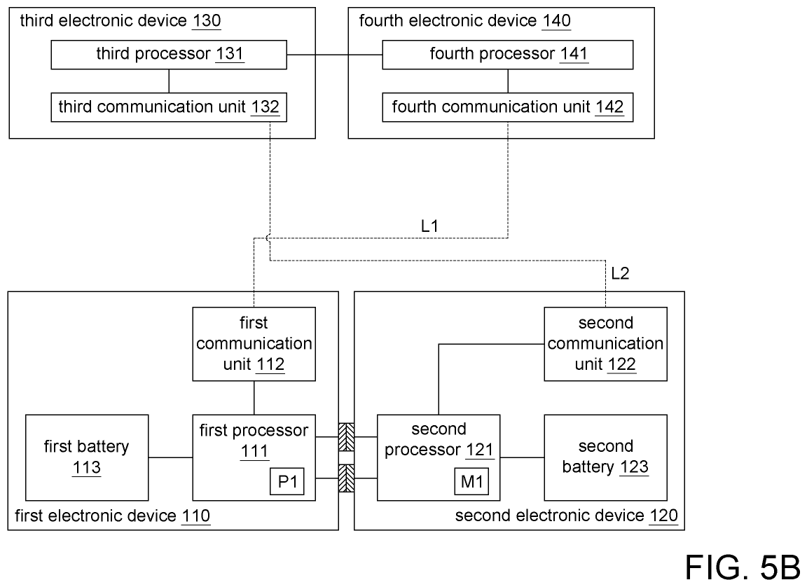

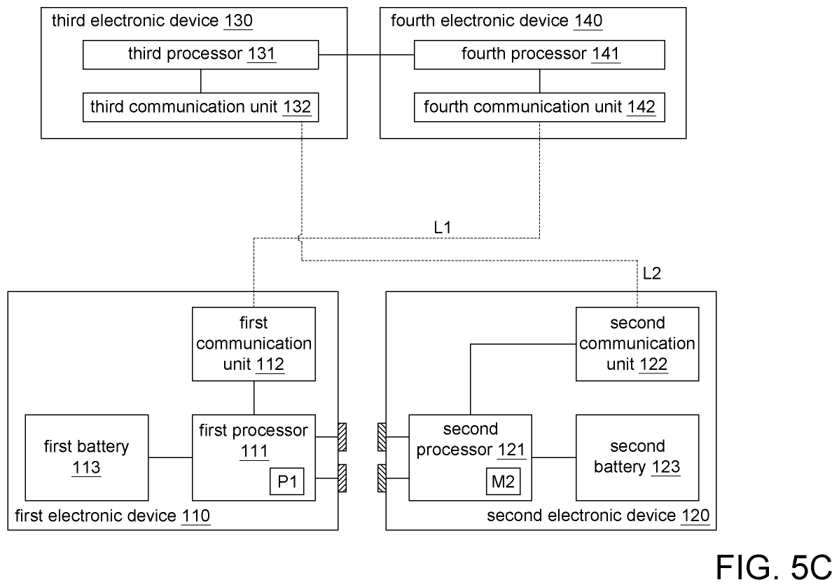

Referring to FIGS. 5A to 5C, FIG. 5A illustrates a diagram view of the first electronic element 110 being wirelessly communicated with the third electronic element 130 through a fourth electronic element 140 according to another embodiment of the present invention, FIG. 5B illustrates a diagram view of the second electronic element 120 of FIG. 5A being wirelessly communicated with the third electronic element 130 in the first operation mode M1, and FIG. 5C illustrates a diagram view of the second electronic element 120 of FIG. 5A being wirelessly communicated with the third electronic element 130 in the second operation mode M2.

The communication method among the electronic element 110, the second electronic element 120 and the third electronic element 130 of FIG. 5A is similar to that of the electronic element 110, the second electronic element 120 and the third electronic element 130 of FIG. 1A, and the difference is in that the first electronic element 110 communicates with the third electronic element 130 through the fourth electronic element 140. In addition, in the present embodiment, the pairing information P1 could be stored in the first electronic element 110 or in the fourth electronic element 140.

As illustrated in FIG. 5A, the fourth electronic element 140 is electrically connected with the third electronic element 130. In an embodiment, the fourth electronic element 140 is, for example, Dongle. The fourth electronic element 140 could be inserted to the third electronic element 130 for being electrically connected with the third electronic element 130.

As illustrated in FIG. 5A, the fourth electronic element 140 includes a fourth processor 141 and a fourth communication unit 142, wherein the fourth processor 141 is electrically connected with the fourth communication unit 142. When the fourth electronic element 140 is inserted to the third electronic element 130, the fourth processor 141 is electrically connected with third processor 131.

In an embodiment, the fourth processor 141 and/or the fourth communication unit 142 could be formed by semiconductor processes. In an embodiment, at least one of the fourth processor 141 and the fourth communication unit 142 could be circuit structure, such as semiconductor chip, semiconductor package, etc. In an embodiment, the fourth processor 141 and the fourth communication unit 142 could be integrated as one piece.

The communication processes among the electronic element 110, the second electronic element 120 and the third electronic element 130 of FIG. 5A to FIG. 5C could be described using the flowchart in FIG. 2.

In step S110, as illustrated in FIG. 5A, the first electronic element 110 communicates with the third electronic element 130 through the fourth electronic element 140 when the second electronic element 120 is electrically connected with the first electronic element 110.

For example, as illustrated in FIG. 5A, the first communication unit 112 of the first electronic element 110 and the fourth communication unit 142 establish the first wireless connection L1 by using a first communication protocol, for example, Proprietary protocol. The first electronic element 110 could communicate with the third electronic element 130 through the first wireless connection L1.

Then, as illustrated in FIG. 5A, the first electronic element 110 or the fourth electronic element 140 transmits the pairing information P1 to the third electronic element 130 through the first wireless connection L1.

In step S120, as illustrated in FIG. 5B, the second electronic element 120 wirelessly communicates with the third electronic element 130, and the second processor 121 of the second electronic element 120 operates in the first operation mode M1.

Furthermore, as illustrated in FIG. 5B, the second communication unit 122 of the second electronic element 120 and the third communication unit 132 of the third electronic element 130 establish the second wireless connection L2 by using the pairing information P1 in the third electronic element 130 and using the second communication protocol, for example, Bluetooth protocol.

Due to the second electronic element 120 being electrically connected with the first electronic element 110, it represents that the second electronic element 120 is not in available state or is not in operation state, the second processor 121 of the second electronic element 120 operates in the first operation mode M1.

In step S130, the first processor 111 of the first electronic element 110 determines whether the second electronic element 120 is detached from the first electronic element 110. If so, the process proceeds step S140, if not, the process returns to step S130.

In step S140, as illustrated in FIG. 5C, the second processor 121 of the second electronic element 120 operates in in the second operation mode M2.

Furthermore, due to the second electronic element 120 being detached from the first electronic element 110, it represents that user intends to use the second electronic element 120, the second processor 121 of the second electronic element 120 changes to operate in different mode, for example, the second mode M2.

As illustrated in FIGS. 5B to 5C, the second electronic element 120 maintains communicating with the third electronic element 130 no matter whether the second electronic element 120 is connected with the third electronic element 130.

In step S150, the first processor 111 of the first electronic element 110 determines whether the second electronic element 120 is electrically connected with the first electronic element 110 again. If so, the process returns to step S120, the second processor 121 of the second electronic element 120 changes the operation mode to be the first operation mode M1, if not, the second electronic element 120 maintains operating in the second operation mode M2.

In another embodiment, the second wireless connection L2 could be established by the second communication unit 122 of the second electronic element 120 and the fourth communication unit 142 of the fourth electronic element 140. In such case, the third electronic element 130 could selectively omit the third communication unit 132.

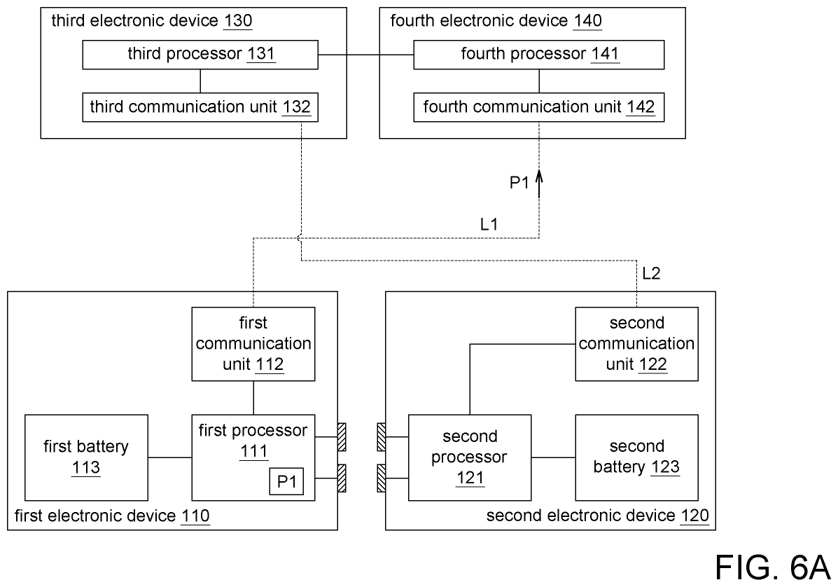

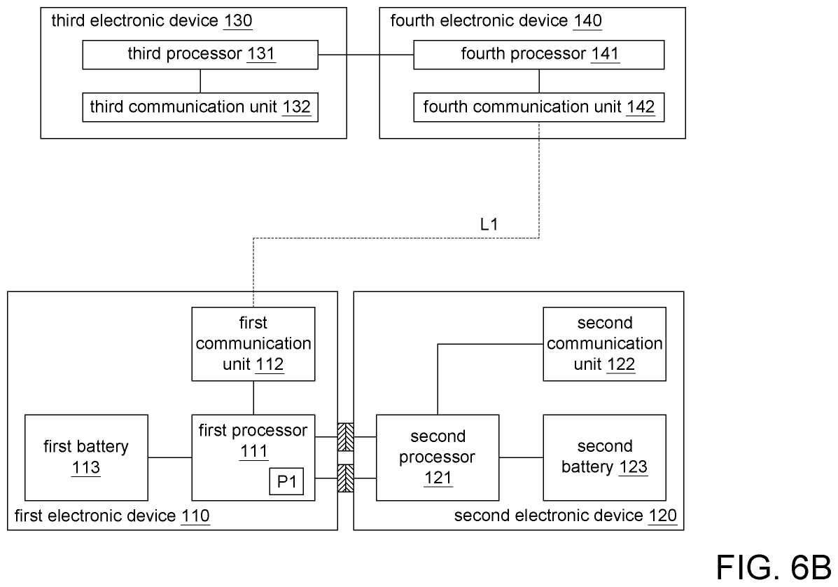

Referring to FIG. 6A to 6B, FIG. 6A illustrates a diagram view of the second electronic element 120 being wirelessly communicated with the third electronic element 130 when the second electronic element 120 disconnects with the third electronic element 130 according another embodiment of the present invention, and FIG. 6B illustrates a diagram view of the second wireless connection L2 is disconnected when the second electronic element 120 of FIG. 6A connects with the third electronic element 130.

The communication processes among the electronic element 110, the second electronic element 120 and the third electronic element 130 of FIGS. 6A and 6B could be described using the flowchart in FIG. 4.

In step S210, as illustrated in FIG. 5A, the first electronic element 110 wirelessly communicates with the third electronic element 130 through the fourth electronic element 140 when the second electronic element 120 is electrically connected with the first electronic element 110.

For example, as illustrated in FIG. 5A, the first communication unit 112 of the first electronic element 110 and the fourth communication unit 142 establish the first wireless connection L1 by using the first communication protocol, for example, Proprietary protocol. The first electronic element 110 could communicate with the third electronic element 130 through the fourth electronic element 140.

Then, as illustrated in FIG. 5A, the first electronic element 110 or the fourth electronic element 140 transmits the pairing information P1 to the third electronic element 130 through the first wireless connection L1.

In step S220, the first processor 111 of the first electronic element 110 determines whether the second electronic element 120 is detached from the first electronic element 110. If so, the process proceeds step S230; if not, the process returns to step S220.

In step S230, as illustrated in FIG. 6A, the second electronic element 120 wirelessly communicates with the third electronic element 130 through the pairing information P1 in the third electronic element 130 when the when the second electronic element 120 disconnects with the third electronic element 130.

Furthermore, in the present embodiment, the second communication unit 122 of the second electronic element 120 and the third communication unit 132 of the third electronic element 130 establish the second wireless connection L2 when the when the second electronic element 120 disconnects with the third electronic element 130.

In step S240, the first processor 111 of the first electronic element 110 determines whether the second electronic element 120 is electrically connected with the first electronic element 110 again. If so, the process proceeds step S250; if not, the second electronic element 120 maintains communicating with the third electronic element 130.

In step S250, as illustrated in FIG. 6B, the second electronic element 120 disconnects with the third electronic element 130 when the second electronic element 120 is electrically connected with the first electronic element 110. Then, the process returns to step S220.

Furthermore, in the resent embodiment, the second wireless connection L2 is disconnected when the second electronic element 120 disconnects with the third electronic element 130.

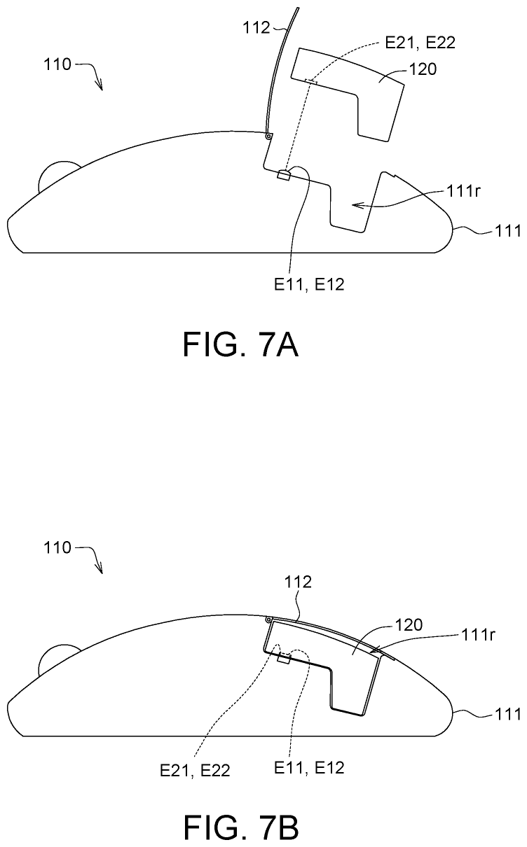

Referring to FIG. 7A, FIG. 7A illustrates a diagram view of structure of the first electronic element 110 of FIG. 1A, and FIG. 7B illustrates a diagram view of the second electronic element 120 being disposed thin the concave portion 111r of FIG. 7A.

As illustrated in FIG. 7A, the first electronic element 110 is, for example, mouse, and the second electronic element 120 is, for example, earphone. The first electronic element 110 includes a casing 111 and a cover 112. The casing 111 has at least one concave portion 111r, wherein each second electronic element 120 is detachably disposed within the corresponding concave portion 111r. In the present embodiment, the concave portion 111r downwardly extends from an upper surface of the casing 111. In another embodiment, the concave portion 111r could upwardly extend from a bottom surface of the casing 111. In other embodiment, the concave portion 111r could laterally extend from a lateral surface of the casing 111.

As illustrated in FIG. 7B, the cover 112 is pivotally connected with the casing 111. The cover 112 could cover the second electronic element 120 disposed within the concave portion 111r.

As illustrated in FIG. 7A, the first electrode E11 and the second electrode E12 are disposed on a surface of the concave portion 111r of the casing 111, and the third electrode E21 and the fourth electrode E22 are disposed on the second electronic element 120. As illustrated in FIG. 7B, when the second electronic element 120 is disposed within the concave portion 111r, the first electrode E11 and the second electrode E12 of the first electronic element 110 are electrically connected with the third electrode E21 and the fourth electrode E22 of the second electronic element 120 respectively.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An electronic device, comprises:
a first electronic element storing a pairing information; and
a second electronic element detachably disposed on the first electronic element;
wherein when the second electronic element is electrically connected with the first electronic element, the first electronic element is wirelessly communicated with a third electronic element;
wherein when the second electronic element is detached from the first electronic element, the second electronic element is wirelessly communicated with the third electronic element through the pairing information.

2. The electronic device as claimed in claim 1, wherein the first electronic element is communicated with the third electronic element through a first communication protocol, the second electronic element is communicated with the third electronic element through a second communication protocol different from the first communication protocol.

3. The electronic device as claimed in claim 1, wherein the first electronic element is communicated with the third electronic element through a communication protocol, the second electronic element is communicated with the third electronic element through the same communication protocol.

4. The electronic device as claimed in claim 1, wherein the first electronic element has a concave portion, and the second electronic element is detachably disposed within the concave portion.

5. The electronic device as claimed in claim 1, wherein the first electronic element comprises:
an electrode; and
a first processor configured to detect whether the second electronic element is detached from the first electronic element according signal of the electrode.

6. The electronic device as claimed in claim 1, wherein the first electronic element comprises:
a first communication unit configured to communicate with the third electronic element;
wherein the second electronic element comprises:
a second communication unit configured to:
when the second electronic element is electrically connected with the first electronic element, the second electronic element communicates with the third electronic element in a first operation mode; and
when the second electronic element is detached from the first electronic element, the second electronic element communicates with the third electronic element in a second operation mode

7. The electronic device as claimed in claim 6, wherein the first operation mode is a sleep mode, and the second operation mode is an active mode.

8. The electronic device as claimed in claim 1, wherein the first electronic element comprises:
a first communication unit configured to communicate with the third electronic element;
wherein the second electronic element comprises:
a second communication unit configured to:
when the second electronic element is electrically connected with the first electronic element, the second electronic element is disconnected with the third electronic element; and
when the second electronic element is detached from the first electronic element, the second electronic element is connected with the third electronic element.

9. The electronic device as claimed in claim 1, wherein the first electronic element is a wireless input device, and the second electronic element is a wireless earphone.

10. The electronic device as claimed in claim 1, wherein the first electronic element wirelessly is communicated with the third electronic element through a fourth electronic element.

11. A communication method, comprises:
wirelessly communicating, by a first electronic element, with a third electronic element when a second electronic element is electrically connected with the first electronic element, wherein the first electronic element stores a pairing information, and the second electronic element is detachably disposed on the first electronic element; and
wirelessly communicating, by the second electronic element, with the third electronic element through the pairing information when the second electronic element is detached from the first electronic element.

12. The communication method as claimed in claim 11, wherein in step of wirelessly communicating, by the first electronic element, with the third electronic element, the first electronic element is communicated with the third electronic element through a first communication protocol; in step of wirelessly communicating, by the second electronic element, with the third electronic element, the second electronic element is communicated with the third electronic element through a second communication protocol different from the first communication protocol.

13. The communication method as claimed in claim 11, wherein in step of wirelessly communicating, by the first electronic element, with the third electronic element, the first electronic element is communicated with the third electronic element through a communication protocol; in step of wirelessly communicating, by the second electronic element, with the third electronic element, the second electronic element is communicated with the third electronic element through the same communication protocol.

14. The communication method as claimed in claim 11, wherein the first electronic element has a concave portion, and the second electronic element is detachably disposed within the concave portion.

15. The communication method as claimed in claim 11, wherein the first electronic element comprises an electrode and further comprises:
detecting, by the first electronic element, whether the second electronic element is detached from the first electronic element according signal of the electrode.

16. The communication method as claimed in claim 11, further comprising:
communicating, by the second electronic element, with the third electronic element in a first operation mode when the second electronic element is electrically connected with the first electronic element; and
communicating, by the second electronic element, with the third electronic element in a second operation mode when the second electronic element is detached from the first electronic element.

17. The communication method as claimed in claim 16, wherein the first operation mode is a sleep mode, and the second operation mode is an active mode.

18. The communication method as claimed in claim 11, further comprising:
disconnecting, by the second electronic element, with the third electronic element when the second electronic element is electrically connected with the first electronic element; and
connecting, by second electronic element, with the third electronic element when the second electronic element is detached from the first electronic element.

19. The communication method as claimed in claim 11, wherein the first electronic element is a wireless input device, and the second electronic element is a wireless earphone.

20. The communication method as claimed in claim 11, wherein the first electronic element wirelessly is communicated with the third electronic element through a fourth electronic element.
